(19) United States
(12) Patent Application Publication
(10) Pub. No.: US 2025/0383832 A1
(43) Pub. Date: Dec. 18, 2025

(54) SYSTEM AND METHOD FOR PROCESSING AN AUDIO SIGNAL

(71) Applicant: Sony Interactive Entertainment Inc., Tokyo (JP)

(72) Inventors: Lewis Thresh, London (GB); Lewis Everest, London (GB); Codie Marie Childs, London (GB); Giacomo Costantini, London (GB); Damian O'Sullivan, London (GB)

(21) Appl. No.: 19/236,261

(22) Filed: Jun. 12, 2025

(30) Foreign Application Priority Data
Jun. 13, 2024 (GB) 2408507.8

(51) Int. Cl. G06F 3/16

(52) U.S. Cl. CPC G06F 3/16

(57) ABSTRACT

A system for processing an audio signal received from a transducer during a field recording session, the system comprising: receiving circuitry configured to receive, from a user, sound source data indicating a desired sound source to be recorded during the field recording session; audio input circuitry configured to receive an audio signal from the transducer; determining circuitry configured to determine whether the audio signal comprises a desired sound corresponding to the desired sound source indicated in the sound source data; and output circuitry configured to output an indication for indicating whether the audio signal comprises the desired sound.

### CROSS-REFERENCE TO RELATED APPLICATION

This application claims priority to United Kingdom (GB) Application Serial No. 2408507.8, filed on Jun. 13, 2024. The disclosure of the prior application is considered part of the disclosure of this application and is incorporated in its entirety into this application.

### FIELD OF THE INVENTION

The present invention relates to a system for processing an audio signal, and a method thereof.

### BACKGROUND

In order to obtain audio data for content such as movies, videogames, audiobooks, and the like, sound designers typically conduct field recording sessions. Such sessions typically involve setting up recording equipment in an outdoor environment (such as a forest, a field, a street, or the like) or an indoor area (such as an office, a train station, an airport terminal, or the like), and recording the sounds emitted in said environment (sounds such as birdsong, rustling trees, road vehicle traffic, and the like).

As will be appreciated, such field recording sessions can last for long periods of time (several hours, for example) and may involve multiple attempts of recording a given sound source in a “trial and error” approach to ensure that the given sound source has indeed been recorded. Such extended time periods are especially apparent in the case where sound designers wish to ensure that the ensure the best possible version of the emitted sound is captured given the environmental circumstances (the lowest signal-to-noise ratio, for example).

As a result, the resulting recordings may be large and may contain a plurality of sounds, with some being suitable for use in content, and others being less so. Such recordings are typically in the form of one long take, which is subsequently edited in a post-processing stage to separate out, process (apply de-noising filters, adjust equalisations, for example), categorise (add identifying metadata, for example) and file away the suitable sounds as audio clips. As will be appreciated, this post-processing stage may thus be a similarly long and tedious process.

The embodiments presented in this disclosure can mitigate or alleviate these issues.

### SUMMARY

In a first aspect, there is provided a system for processing an audio signal received from a transducer during a field recording session, the system comprising: receiving circuitry configured to receive, from a user, sound source data indicating a desired sound source to be recorded during the field recording session; audio input circuitry configured to receive an audio signal from the transducer; determining circuitry configured to determine whether the audio signal comprises a desired sound corresponding to the desired sound source indicated in the sound source data; and output circuitry configured to output an indication for indicating whether the audio signal comprises the desired sound.

Optionally, the determining circuitry may comprise a classifier model trained to classify an input sound as corresponding to a candidate sound source, wherein the determining circuitry may be configured to input the received audio signal into the trained classifier model to determine whether the audio signal comprises the desired sound.

Further optionally, the classifier model may comprise a machine learning model trained using labelled audio data, wherein the labelled audio data may comprise sounds, wherein each sound may be labelled with its corresponding sound source.

Further optionally, the machine learning model may comprise an artificial neural network.

Alternatively or in addition, the system may optionally comprise obtaining circuitry configured to obtain sample audio signals from a sample library, wherein each sample audio signal may comprise a sound corresponding to a respective sound source and metadata indicating the respective sound source, wherein the obtaining circuitry may be configured to do so based on a comparison of the sound source data and the metadata of the sample audio signals; wherein the determining circuitry may be configured to determine whether the audio signal comprises the desired sound by determining whether a given sound within the audio signal shares one or more spectral characteristics with at least one of the obtained sample audio signals.

Further optionally, the system may comprise library storage circuitry configured to store at least a part of the sample library.

Alternatively or in addition, the sound source data may optionally indicate a desired condition in which the desired sound source is to be recorded; the determining circuitry may be configured to determine whether the desired sound within the audio signal satisfies the desired condition; and the output circuitry may be configured to output an indication for indicating whether the desired condition has been satisfied.

Further optionally, the sound source data may indicate one or more of the following desired conditions: a threshold signal-to-noise ratio of the desired sound, a threshold amplitude of the desired sound, and a threshold duration of the desired sound. Other desired conditions may include a indication that a single sound source (a single Robin singing) is to be captured, or that a plurality of the same sound source (a group of Robins singing) is to be captured, for example. These desired conditions may be provided as numeric values, or as text such as “I want a clean sound of a single Robin”, which may be interpreted by the system using natural language processing, or the like.

Alternatively or in addition, the system may optionally comprise audio storage circuitry configured to store at least a part of the audio signal received from the audio input circuitry.

Alternatively or in addition, the sound source data may optionally indicate a plurality of different desired sound sources to be recorded, and the system may comprise register storage circuitry configured to maintain a register indicating which of the desired sound sources have been recorded.

Further optionally, the sound source data may indicate one or more desired conditions in which each desired sound source is to be recorded, and the register indicates how many of and/or the extent to which the desired conditions for each desired sound source are satisfied.

Yet further optionally, the determining circuitry may be configured to determine a recording quality metric for each desired sound source based on the respective indication as to how many of and/or the extent to which the desired conditions for each desired sound source are satisfied, and the register may indicate each determined recording quality metric.

Further optionally, the receiving circuitry may be configured to receive, from the user, a query for querying the register to obtain information regarding the desired sound sources.

Yet further optionally, the output circuitry may be configured to output, in response to the query, an indication for indicating the information regarding the desired sound sources.

Alternatively or in addition, the system may optionally comprise extracting circuitry configured to: extract an audio clip from the received audio signal, wherein the audio clip comprises a desired sound, and output the audio clip for storage.

Further optionally, the extracting circuitry may be configured to label the audio clip with a tag indicating the desired sound source corresponding to the desired sound.

Further optionally, the extracting circuitry may be configured to determine whether a signal-to-noise ratio of the audio clip is less than a threshold signal-to-ratio, and if so, apply a de-noising filter to the audio clip.

Further optionally, the extracting circuitry may be configured to extract a plurality of audio clips each comprising a respective desired sound, and store the plurality of audio clips in a plurality of storage locations according to a category of the respective desired sound.

Alternatively or in addition, the output circuitry may comprise one or more of: a display screen, an audio output system, and a haptic feedback system.

In a second aspect, there is provided a computer-implemented method of processing an audio signal received from a transducer during a field recording session, the method comprising the steps of: receiving, from a user, sound source data indicating a desired sound source to be recorded during the field recording session; receiving an audio signal from the transducer; determining whether the audio signal comprises a desired sound corresponding to the desired sound source indicated in the sound source data; and outputting an indication for indicating whether the audio signal comprises the desired sound.

In a third aspect, there is provided a computer program comprising processor-implementable instructions which cause a processor to perform the method of the second aspect.

In a fourth aspect, there is provided a non-transitory computer-readable storage medium having stored thereon the computer program of the third aspect.

### BRIEF DESCRIPTION OF DRAWINGS

Embodiments of the present disclosure will now be described by way of example with reference to the accompanying drawings, in which:

FIG. 1 schematically illustrates a system according to embodiments of the present disclosure;

FIG. 2 schematically illustrates a system according to embodiments of the present disclosure; and

FIG. 3 is a flowchart illustrating a computer-implemented method according to embodiments of the present disclosure.

### DETAILED DESCRIPTION

A system for processing an audio signal received from a transducer during a field recording session, and a computer-implemented method thereof are disclosed. In the following description, a number of specific details are presented in order to provide a thorough understanding of the embodiments of the present disclosure. It will be apparent, however, to a person skilled in the art that these specific details need not be employed to practice the present disclosure. Conversely, specific details known to the person skilled in the art are omitted for the purposes of clarity where appropriate.

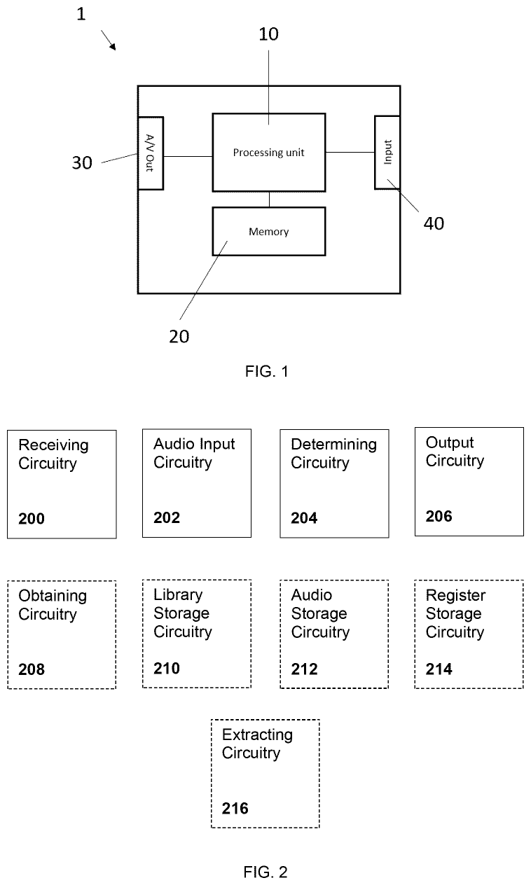

Turning now to FIG. 1, as an example embodiment of the present disclosure, the system may be computing system 1.

Computing system 1 may comprise processing unit 10. Processing unit 10 may be a central processing unit (CPU) and/or a graphical processing unit (GPU). The CPU may be a single or multi core processor. The GPU may be physically separate to the CPU, or may be integrated with the CPU as a system on a chip (SoC).

Computing system 1 may comprise memory 20. Memory 20 may be a RAM, ROM, and/or the like. The RAM may be physically separate to the CPU and/GPU, or may be integrated therewith as part of an SoC. Alternatively or in addition, memory 20 may be an external or internal hard drive, or an external or internal solid state drive.

Computing system 1 may comprise A/V output port 30. A/V output port 30 may enable computing system 1 to transmit audio/visual outputs to one or more other devices/systems. Examples of A/V output port 30 include USB ports, Ethernet® ports, Wi-Fi® ports, Bluetooth® ports, and the like.

Computing system may comprise input port 40. Input port 40 may enable computing system 1 to receive data from one or more other devices/systems. Examples of Input port 40 include USB ports, Ethernet® ports, Wi-Fi® ports, Bluetooth® ports, and the like.

Where components of computing system 1 are not integrated, such components may be connected either by a dedicated data link or via an I/O bus.

### System Overview

Turning now to FIG. 2, in embodiments of the present disclosure, a system for processing an audio signal received from a transducer during a field recording session comprises: receiving circuitry 200 configured to receive, from a user, sound source data indicating a desired sound source to be recorded during the field recording session; audio input circuitry 202 configured to receive an audio signal from the transducer; determining circuitry 204 configured to determine whether the audio signal comprises a desired sound corresponding to the desired sound source indicated in the sound source data; and output circuitry 206 configured to output an indication for indicating whether the audio signal comprises the desired sound.

As mentioned previously, field recording sessions and their associated post-processing stages can be time-consuming processes. However, embodiments of the present disclosure can reduce the amount of time spent recording and post-processing audio by providing a system users (sound designers, for example) may specify (via receiving circuitry 200) the sound sources they wish to record during the field recording session (that is, their desired sound sources), and receive an indication that the desired sound source has been recorded (a visual, audio, and/or haptic notification, for example). This way, sound designers no longer need to undertake a time-consuming trial and error approach to ensure that such sound sources have indeed been recorded during the field recording session. Rather, the system may inform the sound designers that the desired sound source has been captured so that attention may turn towards capturing a different sound source, or towards post-processing.

In order for the system to inform users that the desired sound source has been recorded, the system determines (using determining circuitry 204) whether the recorded audio signal (received at audio input circuitry 202 from a transducer such as a microphone, for example) contains a sound emitted from the desired sound source (birdsong from a Robin, for example). This may be achieved by using machine learning methods such as classifiers, and/or by comparing the spectral characteristics of the audio signal with those of predefined audio samples stored in a sample library. In any case, once a part of the audio signal is determined to contain the sound of (that is, corresponding to) a desired sound source, the system (via output circuitry 206) provides an audio/visual/haptic indication to the user.

Thus, the duration of field recording sessions may be reduced by using embodiments of the present disclosure. As a corollary, the duration of any post-processing stage may similarly be reduced, due to the reduced amount of recorded audio data to post-process. Further reductions to the duration of the post-processing stage shall be discussed later herein with respect to further inventive aspects of the system.

### Sound Source Data

As will be appreciated, in order for the system to inform users that their desired sound source has been recorded during the field recording session, such users should first specify their desired sound source.

As such, receiving circuitry 200 is configured to receive, from a user, sound source data indicating a desired sound source to be recorded during the field recording session. Receiving circuitry 200 may comprise one or more input ports 40, such as USB ports, Ethernet® ports, Wi-Fi® ports, Bluetooth® ports, and the like, for example.

Given that the sound source data need only be an indication of the sound source that the user wishes to record (that is, the desired sound source), such sound source data may simply comprise a textual description of the desired sound. For example, the sound source data may be a file comprising the word “Robin” if the desired sound source is a Robin. The sound source data may be of any format the skilled person deems appropriate. Examples of suitable formats include, .txt, .csv, .json, .rtf, or the like.

The user may transmit the sound source data from a separate device to receiving circuitry 200 via wired or wireless communication methods (USB, Ethernet®, Wi-Fi®, Bluetooth®, or the like). Alternatively or in addition, receiving circuitry 200 may comprise a user interface that enables the user to manually input the sound source data to the system. For example, receiving circuitry 200 may comprise a keyboard, a keypad, a touchscreen displaying a graphical user interface element depicting a keyboard or keypad, or the like.

Optionally, the sound source data may indicate a desired condition in which the desired sound source is to be recorded. A desired condition may be thought of as an audio-related criterion that the recorded sound of the desired sound source (that is, the desired sound) should satisfy, this criterion being specified by the user. Such criteria may be beneficial in that that the duration of the subsequent post-processing stage may be reduced. For example, if the desired sound is captured with at an acceptable signal-to-noise ratio, then a de-noising filter may not need to be applied to the desired sound during post-processing.

For example, the sound source data may indicate one or more of the following desired conditions: a threshold signal-to-noise ratio of the desired sound, a threshold amplitude of the desired sound, and a threshold duration of the desired sound. It will be appreciated that these examples are non-limiting and are not exhaustive; desired conditions other than those explicitly disclosed are contemplated within the scope of the present disclosure.

As will be appreciated, the sound source data may optionally indicate a plurality of different desired sound sources to be recorded; field recording sessions typically involve the recording of multiple different sounds, and so it may be appropriate to provide indications as to whether each of the multiple different sounds to be recorded by the users have indeed been recorded. In this case, the sound source data may further optionally indicate one or more desired conditions in which each desired sound source is to be recorded. Alternatively put, the user may specify identical, similar or different desired conditions/criteria for the different desired sounds.

In any case, once the sound source data is received at receiving circuitry 200, the field recording session may commence (or resume), with the recording equipment (a transducer/microphone) generating and providing an audio signal to audio input circuitry 202.

### Audio Signal

As will be appreciated, in order for the system to inform users that their desired sound source has been recorded during the field recording session, the recording (that is, audio signal) being generated from the transducer/microphone during the field recording session should be provided to the system.

As such, audio input circuitry 202 is configured to receive an audio signal from the transducer. Audio input circuitry may comprise one or more input ports 40, such as USB ports, Ethernet® ports, Wi-Fi® ports, Bluetooth® ports, and the like, for example.

As will be appreciated, a transducer is typically a device that receives an input signal in one form of energy, and outputs a corresponding output signal in another form of energy. In the context of field recordings, the transducer used should be able to receive sound signals (in the form of pressure waves emitted from sound sources) and output corresponding audio signals (in the form of electrical signals). Microphones are a typical example of such transducers.

The audio signal output from the transducer (the recording equipment) may be received at audio input circuitry 202 via wired or wireless communication methods (USB, Ethernet®, Wi-Fi®, Bluetooth®, or the like). Alternatively or in addition, audio input circuitry 202 may comprise an integral (that is, in-built) transducer.

It will be appreciated that (part of) the received audio signal may be stored on a separate system. In this case, embodiments of the present disclosure may comprise audio output circuitry (not shown), which may be configured to output at least a part of the received audio signal to a separate storage device (such as a different computer, or an external hard drive/solid state drive, for example) via wired or wireless communication methods (USB, Ethernet®, Wi-Fi®, Bluetooth®, or the like). The audio output circuitry may comprise one or more A/V output ports 30 such as one or more USB ports, Ethernet® ports, Wi-Fi® ports, Bluetooth® ports, for example.

Alternatively or in addition, (part of) the received audio signal may be stored within the system. In this case, embodiments of the present description may optionally comprise audio storage circuitry 212, which may be configured to store at least a part of the audio signal received from audio input circuitry 202. Audio storage circuitry 212 may comprise memory 20 such as a RAM, ROM, external or internal hard drive, or an external or internal solid state drive, for example.

In any case, the received audio signal may be analysed by determining circuitry 204 to determine whether it contains the sound of the desired sound source (that is, the desired sound).

### Desired Sound

Once the sound source data has been received at receiving circuitry 200, and the field recording session begins (or resumes), the audio signal being received in real-time at audio input circuitry 202 may be analysed to determine whether a part of the audio signal contains the desired sound (that is, the sound of/corresponding to the desired sound source specified in the sound source data).

Therefore, determining circuitry 204 is configured to determine whether the audio signal comprises a desired sound corresponding to the desired sound source indicated in the sound source data. Determining circuitry 204 may comprise one or more processing units 10 such as CPUs and/or GPUs, for example.

Alternatively put, as the audio signal is being received in real-time at audio input circuitry 202, determining circuitry 204 may determine whether (a part of) the audio signal contains a sound whose characteristics resemble those of sounds emitted by/corresponding to the desired sound source. For example, determining circuitry 204 may determine that a sound in the audio signal possesses a variation in frequency which resembles that typically found in the birdsong of a Robin. If the user has specified in the sound source data that they wish to capture a Robin, then determining circuitry 204 may determine that this sound is the desired sound, that is, the sound of the desired sound source (Robin).

Optionally, determining circuitry 204 may utilise machine learning methodologies to determine such resemblances in captured sounds (during the field recording session) and known sounds (captured before the field recording session). For example, a trained classifier model may be executed on determining circuitry 204 to classify a given sound according to its origin (that is, according to which sound source emitted the given sound). Once the given sound is classified according to its origin (sound source), determining circuitry 204 may then determine whether the sound source of the given sound (as classified by the classifier model) is the desired sound source (as specified in the sound source data). Once this determination is made, output circuitry 206 may output the appropriate indication so that the user may know whether the desired sound source was recorded or not.

Hence more generally, determining circuitry 204 may optionally comprise a classifier model trained to classify an input sound as corresponding to a candidate sound source, wherein the determining circuitry is configured to input the received audio signal into the trained classifier model to determine whether the audio signal comprises the desired sound.

Prior to the field recording session, this classifier model may be trained with labelled training data. This labelled training data may come in the form of one or more recorded sounds, with each recorded sound being labelled/tagged with an indication of the sound source which emitted the recorded sound. For example, the labelled training data may comprise a recording of a Robin's birdsong, and the corresponding label/tag may read “Robin”.

Hence more generally, where determining circuitry 204 comprises a classifier model, the classifier model may comprise a machine learning model trained using labelled audio data, wherein the labelled audio data comprises sounds, wherein each sound is labelled with its corresponding sound source.

As will be appreciated, other machine learning methodologies may be utilised. For example, the machine learning model may be a variational autoencoder (VAE), and the training data supplied to it (that is, the recorded sounds) may not be labelled. During training, the VAE may generate a so-called “latent space”, where each recorded sound is organised in a multi-dimensional space whose dimensions are determined by the VAE. For example, the latent space may have the dimensions of frequency, amplitude, duration, and the like, and may organise the training data accordingly. During the field recording, the VAE may place parts of the received audio signal within this same latent space. Determining circuitry 204 may then determine whether a given part of the audio signal is within a threshold distance of one of the recorded sounds of the training data. Output circuitry 206 may subsequently output an indication as to which (if any) of the recorded sounds the given part of the audio signal corresponds. Given that this recorded sounds being used are unlabelled, it may be beneficial in this case to train the VAE with recorded sounds of the desired sound sources (as opposed to any sound sources). This way, the recorded sounds may in themselves be considered sound source data.

In any case, it will be appreciated that any of the aforementioned machine learning models may comprise an artificial neural network (ANN).

Alternatively or in addition to the aforementioned machine learning methodologies, determining circuitry 204 may perform comparisons between captured sounds and known sounds to determine whether the former resemble the latter. For example, the system may have access to a sample library containing a plurality of recorded sounds (or audio samples) each being labelled with their respective sound source. By comparing the desired sound source indicated in the received sound source data with the labels/metadata/tags of the audio samples in the library, the system may obtain audio samples that contain the desired sound. For example, the system may obtain several audio samples of a Robin's birdsong by comparing the metadata of the audio samples with the sound source data of “Robin”.

Hence more generally, embodiments of the present disclosure may comprise obtaining circuitry 208, which may be configured to obtain sample audio signals (that is, audio samples) from a sample library, wherein each sample audio signal comprises a sound corresponding to a respective sound source and metadata (that is, a label/tag, for example) indicating the respective sound source, wherein obtaining circuitry 208 may be configured to do so based on a comparison of the sound source data and the metadata of the sample audio signals. Obtaining circuitry 208 may comprise one or more processing units 10 such as CPUs and/or GPUs, for example.

Determining circuitry 204 may then determine whether any of the obtained audio samples resemble a given sound contained within the received audio signal. For example, determining circuitry 204 may perform a spectral analysis on the given sound to ascertain the various spectral characteristics making up the given sound (frequency components and optionally the amplitudes thereof, for example), and may similarly do so with the obtained audio samples.

Determining circuitry 204 may then determine whether the spectral “fingerprint” of the given sound resembles that of an obtained audio sample, and thereby determine that the given sound is the desired sound. Once this determination is made, output circuitry 206 may output the appropriate indication so that the user may know whether the desired sound source was recorded or not.

Hence more generally, where embodiments of the present disclosure comprise obtaining circuitry 208, determining circuitry 204 may be configured to determine whether the audio signal comprises the desired sound by determining whether a given sound within the audio signal shares one or more spectral characteristics with at least one of the obtained sample audio signals.

It will be appreciated that (part of) the sample library may be stored on a separate system, and obtaining circuitry 208 may access the sample library to obtain audio samples via wired or wireless communication methods (USB, Ethernet®, Wi-Fi®, Bluetooth®, or the like). As such, obtaining circuitry 208 may optionally comprise one or more input ports 40 such as one or more USB ports, Ethernet® ports, Wi-Fi® ports, Bluetooth® ports, for example.

Alternatively or in addition, (part of) the sample library may be stored within the system, and obtaining circuitry 208 may comprise a dedicated data link and/or an I/O bus for accessing the “on-board” sample library. In this case, embodiments of the present disclosure may optionally comprise library storage circuitry 210, which may be configured to store at least a part of the sample library. Library storage circuitry 210 may comprise memory 20 such as a RAM, ROM, external or internal hard drive, or an external or internal solid state drive, for example.

In any case, where the sound source data indicates a desired condition in which the desired sound source is to be recorded, determining circuitry 204 may be configured to determine whether the desired sound within the audio signal satisfies the desired condition. This is to say that once determining circuitry 204 has determined that the audio signal contains an instance of the desired sound (the birdsong of a Robin, for example), it may further determine whether that instance of the desired sound was recorded at an above-threshold signal-to-noise ratio, an above-threshold amplitude, an above-threshold duration, and/or any other audio-related criterion specified by the user. Once this determination is made, output circuitry 206 may output the appropriate indication so that the user may know whether the desired sound source was recorded in accordance with the desired conditions or not.

In any case, where the sound source data indicates a plurality of different desired sound sources to be recorded, determining circuitry 204 may be configured to determine whether the audio signal comprises a desired sound of each of one or more of the different desired sound sources. It will be appreciated that this determination may similarly be carried out using one or more of the aforementioned methods.

To keep track of which of the different desired sound sources have been recorded or not during the field recording session, the system may optionally comprise register storage circuitry 214, which may be configured to maintain a register indicating which of the desired sound sources have been recorded. Register storage circuitry 214 may comprise memory 20 such as a RAM, ROM, external or internal hard drive, or an external or internal solid state drive, for example.

The register may be thought of as a database comprising the plurality of the different desired sound sources, with each desired sound source being associated with a respective indication as to whether it has been recorded/captured or not. As will be appreciated, register storage circuitry 214 may populate this database/register with information regarding the different desired sound sources by using the received sound source data. Moreover, determining circuitry 204 may continuously provide register storage circuitry 214 with indications as to whether a given desired sound source has been recorded, and register storage circuitry 214 may update/maintain the register/database accordingly.

Where the sound source data indicates one or more desired conditions in which each desired sound source is to be recorded, determining circuitry 204 may optionally be configured to determine how many of and/or the extent to which the desired conditions for each desired sound source are satisfied. For example, there may be five desired conditions for a given desired sound source to satisfy, and determining circuitry 204 may determine that three of (that is, how many of) those five desired conditions have been satisfied by a recorded instance of the given desired sound, or may determine that 60% of (that is, the extent to which) the desired conditions have been satisfied by that recorded instance. It will be appreciated that this determination may similarly be carried out using one or more of the aforementioned methods.

In this case, the register (maintained by register storage circuitry 214) may indicate how many of and/or the extent to which the desired conditions for each desired sound source are satisfied. It will be appreciated that this maintaining of the register may similarly be carried out using one or more of the aforementioned methods.

Further, determining circuitry 204 may optionally be configured to determine a recording quality metric for each desired sound source based on the respective indication as to how many of and/or the extent to which the desired conditions for each desired sound source are satisfied, and the register may indicate each determined recording quality metric.

The recording quality metric may be thought of as an indication as to the quality with which desired sound source has been recorded. Determining circuitry 204 may determine a recording quality metric for a given desired sound source by considering how many of and/or the extent to which the desired sound of the given desired sound source satisfies the respective desired conditions, this information either coming from determining circuitry 204 itself or from the register. For example, a desired sound may satisfy three out of five (or 60%) of the desired conditions, and so may determine a recording quality metric of 60%. Alternatively, different weightings may be placed on the different desired conditions. Therefore, if the three satisfied desired conditions are the three highest weighted conditions, then determining circuitry 204 may determine a higher value for the recording quality metric (that is, higher than 60%). In any case, once determined, register storage circuitry 214 update/maintain the register to include/update the recording quality metric of the given desired sound source.

In any case, the register may be queried by the user so that they may ascertain which of the desired sound sources have been recorded, how many of and/or extent to which the desired conditions of a given desired sound source have been satisfied, the recording quality metric of a given desired sound source, or the like. Hence more generally, receiving circuitry 200 may be configured to receive, from the user, a query for querying the register to obtain information regarding the desired sound sources.

### Outputs/Indications

As will be appreciated, once determining circuitry 204 has carried out its determination, the user of the system should be notified of the results of such determination.

As such, output circuitry 206 is configured to output an indication for indicating whether the audio signal comprises the desired sound. Output circuitry 206 may comprise one or more A/V output ports 30 such as one or more USB ports, Ethernet® ports, Wi-Fi® ports, Bluetooth® ports, for example.

As will be appreciated, the outputted indication may be suitable for indicating that the audio signal does comprise the desired sound, or does not. This indication may be transmitted/output via wired or wireless communication methods (USB, Ethernet®, Wi-Fi®, Bluetooth®, or the like) to a separate device, and this separate device may provide the appropriate alert/notification to the user so that the user may be provided with the indication.

As will be appreciated, the outputted alert/notification may be of any format the skilled person deems appropriate. For example, the alert/notification may be visual (a graphical user interface element, for example), an aural (an alert tone, for example), and/or haptic (a vibration/actuation of a haptic element, for example).

Alternatively or in addition to outputting to a separate device, the system may itself comprise one or more devices for alerting/notifying the user of the indication. Hence more generally, output circuitry 206 may comprise one or more of: a display screen (for displaying visual alerts/notifications), an audio output system (for emitting aural alerts/notifications—a loudspeaker, for example), and a haptic feedback system (for outputting haptic alerts/notifications—a rotating eccentric mass, for example).

As will be appreciated, in embodiments of the present disclosure where the sound source data indication a desired conditions in which the desired sound is to be recorded, and determining circuitry 204 is configured to determine whether the desired sound within the audio signal satisfies the desired condition, output circuitry 206 may be configured to output an indication for indicating whether the desired condition has been satisfied. In this case, not only is the user alerted/notified as to whether the desired sound was recorded, but also (in the case where the desired sound was recorded) whether the desired sound satisfies the desired condition.

Also, where receiving circuitry 200 is configured to receive, from the user, a query for querying the register to obtain information regarding the desired sound sources, output circuitry 206 may be configured to output, in response to the query, an indication for indicating the information regarding the desired sound sources. Alternatively put, the user is alerted/notified as to the information that they requested from the register.

In any case, it will be appreciated from the preceding discussion that embodiments of the present disclosure can reduce the amount of time spent recording and post-processing audio, as users may be alerted/notified as to whether a sound sources may wish to record during field session has indeed been recorded, thus removing/reducing the amount of guesswork and uncertainty that typically comes with the trial and error approach to field recording known heretofore. Once provided with the alert/notification, users may turn their attention towards capturing a different sound source or towards post-processing (in the case that the desired sound source has been recorded), or may try to record the desired sound source again (in the case that the desired sound source has not been recorded during the previous attempt).

### Audio Clips

In order to further reduce the time spent post-processing field recordings, it may be beneficial to enable the system to automatically perform some of the post-processing on-the-fly. For example, if the system were able to separate out at least some of the desired sounds from the audio signal during the field recording session, then users would spend less time after the field recording session manually performing such separation.

As such, embodiments of the present disclosure may comprise extracting circuitry 216, which may be configured to extract an audio clip from the received audio signal, wherein the audio clip comprises a desired sound, and output the audio clip for storage. Extracting circuitry 216 may comprise one or more processing units 10 such as CPUs and/or GPUs, for example. Extracting circuitry 216 may comprise one or more A/V output ports 30 such as one or more USB ports, Ethernet® ports, Wi-Fi® ports, Bluetooth® ports, for example, and/or a dedicated data link and/or an I/O bus, for example.

For example, determining circuitry 204 may determine the start and end timestamps demarcating a given desired sound within a subset of the audio signal, and extracting circuitry 216 may extract that subset of the audio signal (containing the given desired sound) as an audio clip. Extracting circuitry 216 may subsequently output the extracted audio clip via wired or wireless communication methods (USB, Ethernet®, Wi-Fi®, Bluetooth®, or the like) to a separate device, and this separate device may store the extracted clips for the user to further post-process, or to import into the content they are creating. Alternatively or in addition, the extracted clip may be stored within the system in one or more storages such as library storage circuitry 210, audio storage circuitry 212, register storage circuitry 214, and/or some other onboard memory 20, for example.

As will be appreciated, output circuitry 206 may optionally be employed downstream of extracting circuitry 216 such that output circuitry 206 may output the extracted audio clip, or extracting circuitry 216 may handle the outputting of the extracted audio clip independently from output circuitry 216.

In any case, the desired sound is extracted from the (potentially hours-long) field recording as the field recording is being recorded (that is, on-the-fly), thereby reducing the amount of time spent manually searching for and extracting the desired sound after the field recording session is over in a post-processing stage.

So that the users may readily discern between extracted audio clips (and thus reduce the time taken to search for extracted audio clips), it may be beneficial to label each extracted audio clip with the desired sound source that emitted the desired sound contained within the audio clip. For example, a given audio clip may comprise a Robin's birdsong, and so the audio clip may be automatically labelled with a tag of “Robin”. Hence more generally, extracting circuitry 216 may be configured to label the audio clip with a tag indicating the desired sound source corresponding to the desired sound.

As will be appreciated, this labelling procedure may be based on the determination carried out by determining circuitry 204. For example, prior to extraction, determining circuitry 204 may have determined that the audio signal contains a Robin's birdsong (that is, a desired sound). Therefore, in order to label the extracted audio clip of the Robin's birdsong, determining circuitry 204 may transmit an indication of the desired sound and/or desired sound source (that is, “Robin” and/or “Robin's birdsong”, for example) to extracting circuitry 216. Extracting circuitry 216 may subsequently label/tag the audio clip with the tag of “Robin”.

To further reduce the time taken to search for extracted audio clips, such audio clips may be categorised and stored accordingly within whichever storage devices and/or circuitries are being used. For example, the extracted audio clips may be categorised according to the desired sound sources which emitted the desired sounds contained with the extracted audio clips. Hence more generally, extracting circuitry 216 may be configured to: extract a plurality of audio clips each comprising a respective desired sound, and store the plurality of audio clips in a plurality of audio clips in a plurality of storage locations according to a category of the respective desired sound.

As will be appreciated, a given storage location may be a given subset of a storage device/circuitry (a memory location within a hard drive/solid state drive, for example). Moreover, the categorisation of the respective desired sounds may be of any level of generalisation the skilled person deems appropriate. For example, an audio clips containing a Robin's birdsong may be put into a category of “Robin”, “bird”, “animal”, “nature”, or the like.

As will be appreciated, this categorisation may be based on the determination carried out by determining circuitry 204. For example, prior to extraction, determining circuitry 204 may have determined that the audio signal contains a Robin's birdsong (that is, a desired sound). Therefore, in order to categorise the extracted audio clip of the Robin's birdsong, determining circuitry 204 may transmit an indication of the desired sound and/or desired sound source (that is, “Robin” and/or “Robin's birdsong”, for example) to extracting circuitry 216. Extracting circuitry 216 may subsequently output the audio clip for storage in a certain storage location dedicated to Robin sounds, bird sounds, animal sounds, nature sounds, or the like, based on a semantic analysis of the indication provided by determining circuitry 204.

In order to further expedite the manual post-processing stage, the extracted audio clips may be subjected to automatic post-processing on-the-fly. For example, a given extracted audio clip may have a de-noising filter automatically applied thereto during the field recording session in order that the desired sound may be made more prominent within the audio clip. Hence more generally, extracting circuitry 216 may be configured to determine whether a signal-to-noise ratio of the audio clip is less than a threshold signal-to-ratio, and if so, apply a de-noising filter to the audio clip. This example is entirely non-limiting; the skilled person will appreciate that other on-the-fly post-processing steps may be carried out by extracting circuitry 216. For example, extracting circuitry 216 may be configured to normalise the extracted audio clip, and/or apply one or more limiters to the extracted audio clip, and/or apply one or more filters to the extracted audio clip (such as low-pass or high-pass filters, for example), and/or adjust the equalisation of the extracted audio clip.

As will be appreciated, where determining circuitry 204 is configured to determine whether the desired sound within the audio signal satisfies a desired condition, and that desired condition is a threshold signal-to-noise ratio of the desired sound, then extracting circuitry 216 may alternatively/additionally utilise the determination by determining circuitry 216 that the desired sound does not satisfy the desired condition as the trigger to apply the de-noising filter to the audio clip.

In any case, the amount of time spent manually post-processing a field recording may be reduced, as at least part of the field recording may be automatically separated out into audio clips on-the-fly, and such audio clips may be subjected to de-noising as appropriate on-the-fly.

### Method Overview

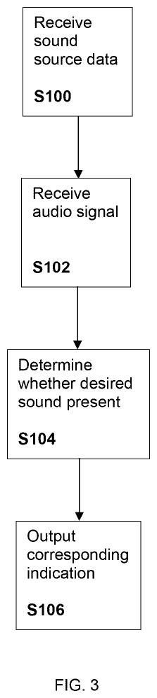

Turning now to FIG. 3, a computer-implemented method of processing an audio signal received from a transducer during a field recording session comprises the steps of:

S100: receiving, from a user, sound source data indicating a desired sound source to be recorded during the field recording session, as described elsewhere herein.

S102: receiving an audio signal from the transducer, as described elsewhere herein.

S104: determining whether the audio signal comprises a desired sound corresponding to the desired sound source indicated in the sound source data, as described elsewhere herein.

S106: outputting an indication for indicating whether the audio signal comprises the desired sound, as described elsewhere herein.

It will be apparent to a person skilled in the art that variations in the above method corresponding to operation of the various embodiments of the system as described and claimed herein are considered within the scope of the present disclosure.

It will be appreciated that the above methods may be carried out on conventional hardware (such as computing system 1) suitably adapted as applicable by software instruction or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

The foregoing discussion discloses and describes merely exemplary embodiments of the present disclosure. As will be understood by those skilled in the art, the present disclosure may be embodied in other specific forms without departing from the spirit or essential characteristics thereof. Accordingly, the present disclosure is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A system for processing an audio signal received from a transducer during a field recording session, the system comprising:
a receiving circuitry configured to receive, from a user, sound source data indicating a desired sound source to be recorded during the field recording session;
an audio input circuitry configured to receive the audio signal from the transducer;
a determining circuitry configured to determine whether the audio signal comprises a desired sound corresponding to the desired sound source indicated in the sound source data; and
an output circuitry configured to output an indication for indicating whether the audio signal comprises the desired sound.

2. The system according to claim 1, wherein the determining circuitry comprises a classifier model trained to classify an input sound as corresponding to a candidate sound source, wherein the determining circuitry is configured to input the received audio signal into the trained classifier model to determine whether the audio signal comprises the desired sound.

3. The system according to claim 2, wherein the classifier model comprises a machine learning model trained using labelled audio data, wherein the labelled audio data comprises sounds, wherein each sound is labelled with its corresponding sound source.

4. The system according to claim 1, further comprising:
an obtaining circuitry configured to obtain sample audio signals from a sample library, wherein each sample audio signal comprises a sound corresponding to a respective sound source and metadata indicating the respective sound source, wherein the obtaining circuitry is configured to do so based on a comparison of the sound source data and the metadata of the sample audio signals,
wherein the determining circuitry is configured to determine whether the audio signal comprises the desired sound by determining whether a given sound within the audio signal shares one or more spectral characteristics with at least one of the obtained sample audio signals.

5. The system according to claim 4, further comprising a library storage circuitry configured to store at least a part of the sample library.

6. The system according to claim 1, wherein:
the sound source data indicates a desired condition in which the desired sound source is to be recorded,
the determining circuitry is configured to determine whether the desired sound within the audio signal satisfies the desired condition, and
the output circuitry is configured to output an indication for indicating whether the desired condition has been satisfied.

7. The system according to claim 6, wherein the sound source data indicates one or more of:
i. a threshold signal-to-noise ratio of the desired sound;
ii. a threshold amplitude of the desired sound; and
iii. a threshold duration of the desired sound.

8. The system according to claim 1, further comprising an audio storage circuitry configured to store at least a part of the audio signal received from the audio input circuitry.

9. The system according to claim 1, wherein the sound source data indicates a plurality of different desired sound sources to be recorded, and the system further comprises:
a register storage circuitry configured to maintain a register indicating which of the plurality of different desired sound sources have been recorded.

10. The system according to claim 9, wherein the sound source data indicates one or more desired conditions in which each desired sound source is to be recorded, and the register indicates how many of and/or to what extent the desired conditions for each desired sound source are satisfied.

11. The system according to claim 10, wherein the determining circuitry is configured to determine a recording quality metric for each desired sound source based on a respective indication as to how many of and/or to what extent the desired conditions for each desired sound source are satisfied.

12. The system according to claim 9, wherein the receiving circuitry is configured to receive, from the user, a query for querying the register to obtain information regarding the desired sound sources.

13. The system according to claim 12, wherein the output circuitry is configured to output, in response to the query, an indication for indicating the information regarding the desired sound sources.

14. The system according to claim 1, further comprising an extracting circuitry configured to:
extract an audio clip from the received audio signal, wherein the audio clip comprises the desired sound, and
output the audio clip for storage.

15. The system according to claim 14, wherein the extracting circuitry is further configured to label the audio clip with a tag indicating the desired sound source corresponding to the desired sound.

16. The system according to claim 14, wherein the extracting circuitry is further configured to determine whether a signal-to-noise ratio of the audio clip is less than a threshold signal-to-ratio, and if so, apply a de-noising filter to the audio clip.

17. The system according to claim 14, wherein the extracting circuitry is further configured to:
extract a plurality of audio clips each comprising a respective desired sound, and
store the plurality of audio clips in a plurality of storage locations according to a category of the respective desired sound.

18. The system according to claim 14, wherein the output circuitry comprises one or more of:
i. a display screen;
ii. an audio output system; and
iii. a haptic feedback system.

19. A computer-implemented method of processing an audio signal received from a transducer during a field recording session, the method comprising:
receiving, from a user, sound source data indicating a desired sound source to be recorded during the field recording session;
receiving the audio signal from the transducer;
determining whether the audio signal comprises a desired sound corresponding to the desired sound source indicated in the sound source data; and
outputting an indication for indicating whether the audio signal comprises the desired sound.

20. A non-transitory computer-readable storage medium storing one or more instructions executable by a computing system to perform operations to process an audio signal received from a transducer during a field recording session, the operations comprising:
receiving, from a user, sound source data indicating a desired sound source to be recorded during the field recording session;
receiving the audio signal from the transducer;
determining whether the audio signal comprises a desired sound corresponding to the desired sound source indicated in the sound source data; and
outputting an indication for indicating whether the audio signal comprises the desired sound.
